(19) United States
(12) Patent Application Publication
(10) Pub. No.: US 2026/0095819 A1
(43) Pub. Date: Apr. 2, 2026

(54) WIRELESS COMMUNICATION NETWORK HANDOVERS

(71) Applicant: DISH Wireless L.L.C., Englewood, CO (US)

(72) Inventor: Xiaowen Robinson, Great Falls, VA (US)

(21) Appl. No.: 18/900,173

(22) Filed: Sep. 27, 2024

(51) Int. Cl. H04W 36/00; H04W 8/02; H04W 84/04

(52) U.S. Cl. CPC H04W 36/0022; H04W 8/02; H04W 84/042

(57) ABSTRACT

Implementations are described herein for wireless communication network handovers. One or more components of a visited public land mobile network (VPLMN) may send, to a packet data gateway (PGW) of a home public land mobile network (HPLMN), a create session request. The PGW of the HPLMN may send, to the one or more components of the VPLMN, a create session response that includes an identifier of the PGW. A mobility management entity (MME) of the VPLMN may send, to a home subscriber service (HSS) of the HPLMN, the PGW identifier. The HSS may use the PGW for a handover process, such as a handover from voice over Internet Protocol (VoIP) to voice over wireless local area network (WLAN).

### BACKGROUND

Wireless communication refers to the transmission of data without the need for physical connections such as cables or wires. This technology utilizes electromagnetic waves, such as radio frequency waves, to transmit information across distances. Wireless communication systems can include cellular networks and wireless local area networks, among other examples, that enable devices such smartphones, laptops, and other wireless devices to connect and exchange data seamlessly. This technology has revolutionized the way humans communicate, providing mobility, flexibility, and convenience by allowing users to stay connected virtually anywhere.

### BRIEF DESCRIPTION OF THE DRAWINGS

The present disclosure is illustrated by way of example, and not by way of limitation, in the figures of the accompanying drawings.

FIG. 1 is a block diagram of a wireless communication system that includes a handover component for performing a handover between wireless communication networks, according to at least one embodiment.

FIG. 2 is a flow diagram of an example method for performing a handover between a first wireless communication network and a second wireless communication network, according to at least one embodiment.

FIG. 3 is a block diagram showing example network components used for communications in cellular networks and wireless local area networks, according to at least one embodiment.

FIG. 4 is a block diagram of an example method of a general packet radio service tunneling protocol proxy (GTP proxy) obtaining a packet data gateway identifier and transferring the packet gateway identifier to the MME for a handover between a cellular network and a wireless local area network, according to at least one embodiment.

FIG. 5 is a block diagram of an example method of a general packet radio service tunneling protocol proxy (GTP proxy) obtaining a packet data gateway identifier and redirecting the traffic towards the packet data gateway for a handover between a cellular network and a wireless local area network, according to at least one embodiment.

FIG. 6 is a flow diagram of a method of obtaining a packet data gateway identifier for a handover between a cellular network and a wireless local area network, according to at least one embodiment.

### DETAILED DESCRIPTION

Technologies for providing handovers between wireless communication networks are described. The following description sets forth numerous specific details, such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Voice over Internet Protocol (VoIP) is a process of delivering voice communications and multimedia sessions over an Internet Protocol (IP) network. One example of VoIP is voice over LTE (VoLTE). VoLTE is a technology that enables voice calls to be made over LTE (4G) networks rather than relying on traditional circuit-switched voice networks. This transition to the LTE data network for voice calls results in several advantages, including improved call quality due to higher bandwidth and the use of advanced audio codecs like adaptive multi-rate wideband. Additionally, VoLTE allows for the simultaneous use of voice and data services, meaning users can browse the Internet, use apps, and stream media while on a call. VoLTE also supports faster call setup times and enables enhanced services such as video calling and rich communication services, which offer features such as instant messaging, file sharing, and location sharing. Another example of VoIP is voice over New Radio (VoNR), which is a technology that allows voice calls to be made directly over a new radio (NR) (5G) network, taking full advantage of the enhanced capabilities and performance characteristics of 5G.

Voice over wireless local area network (VoWLAN) refers to the delivery of voice communication services over any type of wireless local area network (WLAN). One example of VoWLAN is voice over Wi-Fi® (VoWi-Fi), which allows voice calls to be made over a Wi-Fi® network instead of a cellular network, providing an advantage in areas with poor or no cellular coverage but strong Wi-Fi® signals, such as indoors or remote locations. VoWLAN can lead to cost savings, particularly for international calls, by utilizing VoWLAN networks instead of cellular roaming services. This technology supports seamless handover between VoWLAN and cellular networks, ensuring uninterrupted calls as users move between coverage areas. VoWLAN is accessible anywhere with a stable VoWLAN connection, making it ideal for use in homes, offices, and public spaces with VoWLAN access, thereby extending the reach of mobile voice services beyond traditional cellular boundaries.

Handovers are an essential aspect of wireless communication systems, ensuring that active calls and data sessions remain uninterrupted as users move between different network coverage areas. Handovers can be performed to maintain service continuity, optimize network resources, and ensure a seamless user experience. In general, a handover involves transferring an ongoing call or data session from one cell or network to another cell or network without dropping the connection. This process can be triggered by factors such as signal strength, network congestion, or user movement. A handover between VoIP and VoWLAN may be performed to leverage the strengths of both technologies, such as utilizing VoIP for high-quality calls in areas with robust cellular coverage and switching to VoWLAN in areas with strong WLAN signals but weak cellular coverage. This dynamic switching enhances overall call reliability and quality, ensuring users receive the best possible service regardless of their location.

In a cellular home routed roaming scenario, a visited public land mobile network (VPLMN) can implement a general packet radio service (GPRS) tunneling protocol (GTP) proxy to peer with a home public land mobile network (HPLMN) packet data gateway (PGW). The GTP proxy can appear, to a VPLMN mobility management entity (MME), as if it were the HPLMN PGW. Upon the completion of an LTE attach procedure for a VoIP roaming call setup, the VPLMN MME may update an HPLMN home subscriber server (HSS) with the GTP proxy IP address as the anchor point (rather than the HPLMN PGW IP address). During a VoIP to VoWLAN handover, the VoWLAN call setup may utilize the PGW address (stored in the HPLMN HSS) on which the VoIP call is currently anchored, select the PGW, and leverage the UE VoLTE session context information maintained by the PGW to accomplish the handover from the cellular network to the WLAN network. This may increase a likelihood of the VoIP to VoWLAN handover failing, for example, due to the PGW address in the HPLMN HSS being the HTTP proxy address rather than the HPLMN PGW address. Additionally, the handover may fail due to the GTP proxy not storing UE VoLTE session context information. For example, the GTP proxy may not store UE VoLTE session context information, which is in contrast to the HPLMN PGW, which typically does store the UE VoLTE session context information. Further, the handover may fail due to an HPLMN evolved packet data gateway (ePDG) having no connectivity to the VPLMN GTP proxy, or due to VoWLAN using GTP proxies not being supported, among other examples.

Aspects of the present disclosure address the above and other deficiencies by providing improved handover processes between wireless communication networks, such as VoIP to VoWLAN handovers. In some aspects, a VPLMN of a UE may include at least a GTP proxy, a serving gateway (SGW), and an MME, and an HPLMN of the UE may include at least a PGW and an HSS. The MME of the VPLMN may provide the SGW with a create session request message. The create session request message may indicate the selected PGW for the SGW to forward the message to. The SGW of the VPLMN may forward the create session request message to the GTP proxy as specified as the PGW in the create session request message provided by the MME. In a first example, the GTP proxy may select the HPLMN PGW and send the create session request message to the HPLMN PGW. For example, the GTP proxy may set a create session request message forward indication bit to a high value and may forward the create session request message that includes the create session request message forward indication bit having the high value to the HPLMN PGW. The HPLMN PGW may send, to the GTP proxy, a create session response message that includes the PGW identifier. The GTP proxy may provide the create session response message to the SGW of the VPLMN, and the SGW may provide the crease session response message to the MME of the VPLMN. In a second example, the GTP proxy may respond to the SGW with an error message. For example, the GTP proxy may provide, after selecting a PGW of the HPLMN, to the SGW, a create session request rejection that includes an alternative PGW indicator with the PGW identifier, such as an alternative fully qualified domain name (FQDN) of the PGW. The SGW forwards the rejection message to the MME. Based on receiving the create session request rejection, the MME of the VPLMN may send, to the SGW, a second create session request message that contains the PGW identifier as specified in the alternative PGW indicator information element of the rejection message. Based on the included PGW identifier, the SGW forwards the create session request message to the HPLMN PGW. In both the first example and the second example, the MME of the VPLMN may send the PGW identifier to the HSS of the HPLMN, thereby enabling the PGW identifier to be stored by the HSS of the HPLMN and to be used for VoIP to VoWLAN handovers.

Some advantages of the present disclosure include improved handover processes between wireless communication networks. Some advantages of the present disclosure include enabling a GTP proxy of a VPLMN to obtain a PGW identifier of an HPLMN for a handover from VoIP to VoWLAN. Some advantages of the present disclosure include enabling the SGW to provide the MME of the VPLMN with the PGW identifier corresponding to the PGW of the HPLMN. Some advantages of the present disclosure include enabling the MME of the VPLMN to provide the HSS of the HPLMN with the PGW identifier, rather than the GTP proxy IP address, thereby improving a likelihood that the correct PGW is used during the handover from the VoIP to the VoWLAN. Some advantages of the present disclosure include enabling the GTP proxy to store UE VoIP session context information. Some advantages of the present disclosure include enabling an ePDG of the HPLMN to be connected to the GTP proxy of the VPLMN. Some advantages of the present disclosure include enabling VoWLAN communications using a GTP proxy. These example advantages, among others, are described in more detail below.

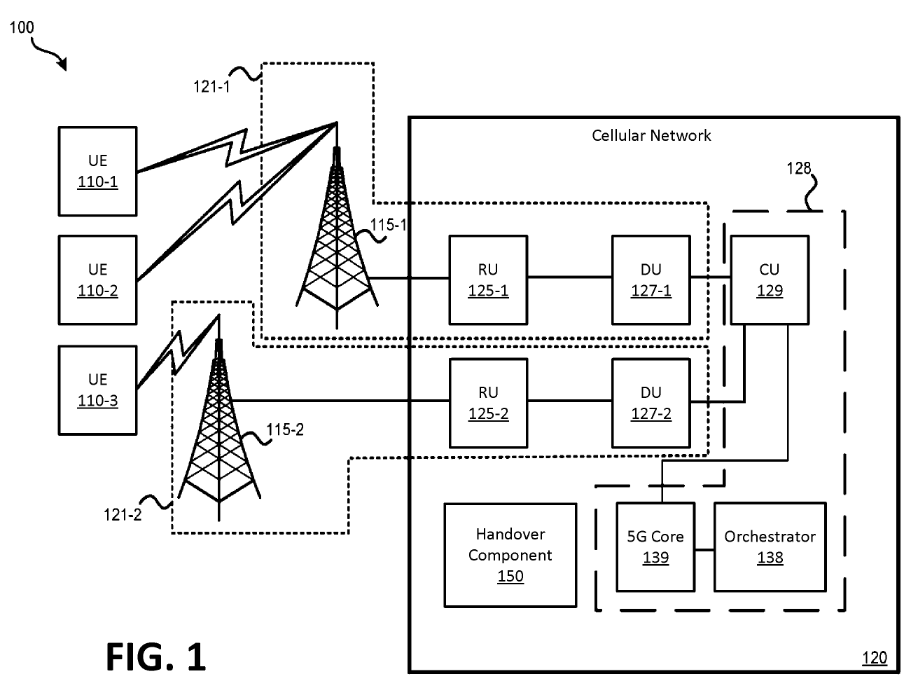

FIG. 1 is a block diagram of a wireless communication system 100 that includes a handover component 150 for performing handovers between wireless communication networks, according to at least one embodiment. The wireless communication system 100 may include a 5G NR cellular network. Other types of cellular networks, such as 4G, 6G, or 7G cellular networks, among other examples, may also be possible. In some aspects, wireless communication system 100 includes one or more user equipments (UEs) 110 (shown as UE 110-1, UE 110-2, and UE 110-3), a base station (BS) 115, a cellular network 120, one or more radio units (RU) 125, one or more distributed units (DU) 127, one or more centralized units (CU) 129, a 5G core 139, and an orchestrator 138. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider to accommodate a location where the functionality of such components is needed.

The UE 110 can represent various types of end-user devices, such as cellular phones, smartphones, cellular modems, cellular-enabled computerized devices, sensor devices, gaming devices, access points (APs), and computerized devices capable of communicating via the cellular network. Generally, the UE can represent any type of device that has an incorporated 5G interface, such as a 5G modem. Examples can include sensor devices, Internet of Things (IoT) devices, manufacturing robots, unmanned aerial (or land-based) vehicles, and network-connected vehicles, among other examples. Depending on the location of individual UEs, the UE 110 may use RF to communicate with various base stations of the cellular network 120. In some aspects, a first base station (base station 121-1) can include structure 115-1, RU 125-1, and DU 127-1. Structure 115-1 may be any structure to which one or more antennas (not illustrated) of the base station are mounted. For example, structure 115-1 may be a dedicated cellular tower, a building, a water tower, or any other manufactured or natural structure to which one or more antennas can reasonably be mounted to provide cellular coverage to a geographic area. A second base station (base station 121-2) can include structure 115-2, RU 125-2, and DU 127-2.

Real-world implementations of the system 100 can include many (e.g., thousands) of base stations and many CUs and 5G core 139. The base station 115 can include one or more antennas that allow the RUs 125 to communicate wirelessly with the UEs 110. The RUs 125 can represent an edge of the cellular network 120 where data is transitioned to a wireless communication. The radio access technology (RAT) used by RU 125 may be 5G NR RAT, or some other RAT. The remainder of the cellular network 120 may be based on an exclusive 5G architecture, a hybrid 4G/5G architecture, a 4G architecture, or some other cellular network architecture. The base station equipment 121 may include an RU (e.g., RU 125-1) and/or a DU (e.g., DU 127-1).

One or more RUs, such as RU 125-1, may communicate with the DU 127-1. As an example, at a cell site, three RUs may be present, each being connected with the same DU. Different RUs may be present for different portions of the spectrum. For example, a first RU may operate on the spectrum in the citizens broadcast radio service (CBRS) band while a second RU may operate on a separate portion of the spectrum, such as, for example, band 71. One or more DUs, such as the DU 127-1, may communicate with the CU 129. Collectively, an RU, DU, and CU create a gNodeB, which serves as the radio access network (RAN) of the cellular network 120. The CU 129 can communicate with the 5G core 139. The specific architecture of cellular network 120 can vary by embodiment. Edge cloud server systems outside of the cellular network 120 may communicate, either directly, via the Internet, or via some other network, with components of the cellular network 120. For example, the DU 127-1 may be able to communicate with an edge cloud server system without routing data through the CU 129 or the 5G core 139. Other DUs may or may not have this capability.

While FIG. 1 illustrates various components of the cellular network 120, other aspects of the cellular network 120 can vary the arrangement, communication paths, and specific components of the cellular network 120. While RU 125 may include specialized radio access componentry to enable wireless communication with UE 110, other components of the cellular network 120 may be implemented using either specialized hardware, specialized firmware, and/or specialized software executed on a general-purpose server system. In an O-RAN arrangement, specialized software on general-purpose hardware may be used to perform the functions of components such as the DU 127, the CU 129, and the 5G core 139. Functionality of such components can be co-located or located at disparate physical server systems. For example, certain components of the 5G core 139 may be co-located with components of the CU 129.

In a possible virtualized O-RAN implementation, the CU 129, the 5G core 139, and/or the orchestrator 138 can be implemented virtually as software being executed by general-purpose computing equipment, such as in a data center of a cloud-computing platform. Therefore, depending on needs, the functionality of the CU and/or the 5G core may be implemented locally to each other and/or specific functions of any given component can be performed by physically separated server systems (e.g., at different server farms). For example, some functions of the CU may be located at a same server facility as where the DU is executed, while other functions are executed at a separate server system. In the illustrated embodiment of system 100, cloud-based cellular network components 128 include the CU 129, the 5G core 139, and the orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

In some aspects, Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by the orchestrator 138. The orchestrator 138 can represent various software processes executed by underlying computer hardware. The orchestrator 138 can monitor the cellular network 120 and determine the amount and location at which cellular network functions should be deployed to meet or attempt to meet service level agreements (SLAs) across slices of the cellular network.

The orchestrator 138 can allow for the instantiation of new cloud-based components of the cellular network 120. As an example, to instantiate a new core function, the orchestrator 138 can perform a pipeline of calling the core function code from a software repository incorporated as part of, or separate from, the cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on the cellular network 120. The cellular network 120 may be shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for the UE can be varied on different slices. A network slice can be configured to provide sufficient resources for a particular application to be properly executed and delivered (e.g., gaming services, video services, voice services, location services, sensor reporting services, and data services). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at the RU 125-1 and the DU 127-1, a second set of network slices, which may only partially overlap or may be wholly different from the first set, may be reserved at the RU 125-2 and the DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as the DU 127, the CU 129, the orchestrator 138, and the 5G core 139 may include various software components that are required to communicate with each other, handle large volumes of data traffic, and to properly respond to changes in the network. In order to ensure not only the functionality and interoperability of such components, but also the ability to respond to changing network conditions and the ability to meet or perform above vendor specifications, significant testing may need to be performed.

The 5G core 139, which can be physically distributed across data centers or located at a central national data center (NDC), can perform various core functions of the cellular network. In some aspects, the 5G core 139 may include network resource management components, policy management components, subscriber management components, and packet control components, among other examples. Individual components may communicate on a bus, thus allowing various components of the 5G core 139 to communicate with each other directly. The 5G core 139 is simplified to show some key components. Implementations can involve additional other components.

Network resource management components can include network repository function (NRF) and network slice selection function (NSSF). The NRF can allow the 5G network functions (NFs) to register and discover each other via a standards-based application programming interface (API). The NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include a unified data management (UDM) component and an authentication server function (AUSF). The UDM can allow for generation of authentication vectors, user identification handling, NF registration management, and retrieval of UE individual subscription data for slice selection. The AUSF may perform authentication with the UE. Packet control components can include access and mobility management function (AMF) and a session management function (SMF). The AMF can receive connection-and session-related information from the UE and is responsible for handling connection and mobility management tasks. The SMF is responsible for interacting with the decoupled data plane, creating updating, and removing protocol data unit (PDU) sessions, and managing session context with a user plane function (UPF). The UPF can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client or user point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some aspects, the cellular network 120 includes a locality component 150 that improves network edge protection in the cellular network 120. The locality component 150 may be implemented, for example, in a security edge protection proxy of a home network or in a network repository function of the home network, among other examples. In some aspects, the locality component 150 may determine a location of a mobile device that is connecting to a visiting network based on the mobile device being outside of a coverage area of a home network and inside of the coverage area of the visiting network. Additionally, or alternatively, the locality component 150 may determine a location of the coverage area of the visiting network to which the mobile device is connecting. The locality component 150 may provide the location information to one or more other components of the home network to be used for prioritizing local network functions of the home network. For example, the location information provided by the locality component 150 may be used to identify a primary local network function (e.g., a default AUSF) to be used by the visiting network for authenticating the mobile device and may identify one or more secondary local network functions (e.g., one or more backup AUSFs) to be used by the visiting network for authenticating the mobile device in an event that the primary local network function is unavailable. Additional details regarding these features are described below.

In some aspects, the cellular network 120 includes a handover component 150 that enables handovers between wireless communication networks. For example, the handover component 150 may perform a handover from a first wireless communication network, such as a cellular network, to a second wireless communication network, such as a wireless local area network. In some aspects, the handover component 150 may be, or may include, an MME, an SGW, or any other network entity or component configured to perform handovers between wireless communication networks. Additional details regarding these features are described below.

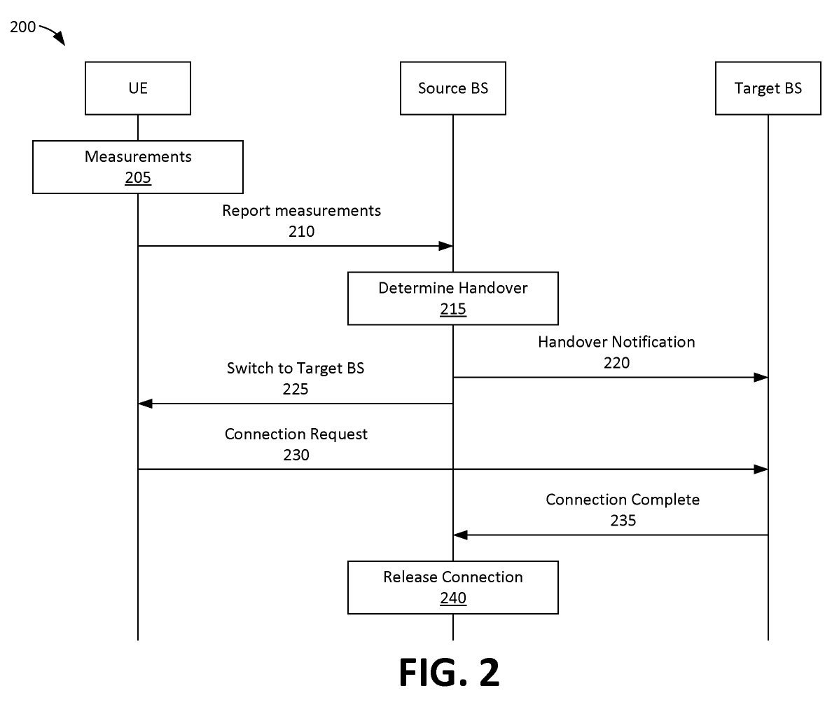

FIG. 2 is a flow diagram of an example method 200 for performing a handover between a first wireless communication network and a second wireless communication network, according to at least one embodiment. An environment 200 may include a UE, a source BS, and a target BS. In some aspects, the UE, the source BS, and the target BS may correspond to the UE 110, BS 115-1, and BS 115-2, respectively.

A handover is a process by which a UE (for example, a mobile device) switches from one base station (or access point) to another base station (or access point) as the UE moves through the coverage area of a wireless communication network. This process ensures the continuity of ongoing calls or data sessions without interruption, maintaining the quality of service and connectivity for the user. In some examples, the handover may be initiated based on a signal strength. As the UE moves away from the coverage area of a first base station, the signal strength from that first base station weakens. To maintain a strong and stable connection, the device may need to switch to a second base station with a stronger signal. In some other examples, the handover may be initiated based on load balancing. For example, to optimize network performance and avoid congestion, a network may initiate a handover to distribute the load more evenly across base stations. In some other examples, the handover may be initiated based on a quality of service (QoS) requirement. For example, if a current connection cannot support a required QoS, the network may hand over the device to a base station that can better meet the QoS requirements. In some other examples, the handover may be initiated based an interference measurement. For example, high levels of interference or poor signal quality may prompt a handover to a different base station with a clearer channel. In some other examples, the handover may be performed based on a combination of conditions and/or may be performed based on one or more network policies.

At operation 205, the UE performs one or more measurements. The UE may receive signals from one or more neighboring base stations, including but not limited to the target base station, and may measure one or more characteristics of the signals. For example, the UE may measure a reference signal received power (RSRP), a reference signal received quality (RSRQ), a signal-to-interference-plus-noise ratio (SINR), a received signal strength indicator (RSSI), or a channel quality indicator (CQI), among other examples, of the signals received from the neighboring base stations.

At operation 210, the UE reports the measurements to the source base station. In some aspects, the UE may report the measurements to the source base station at one or more intervals.

At operation 215, the source base station determines that a handover is to be performed from the source base station to the target base station. The source base station (or network controller) may evaluate the measurements received from the UE against predefined thresholds and criteria. For example, the source base station may receive an RSRP measurements from the UE and may compare the RSRP measurement to an RSRP threshold. If the measurement indicates that a handover is necessary (for example, if the RSRP is less than the RSRP threshold), the source base station may determine that a handover is to be initiated. The source base station prepares for the handover by selecting a target base station.

At operation 220, the source base station informs the target base station about the impending handover. The source base station may provide the target base station with certain details such as an identifier of the UE and context associated with an existing session between the source BS and the UE, among other examples.

At operation 225, the source base station instructs the UE to switch to the target base station.

At operation 230, the UE sends a connection request to the target base station. For example, the UE may synchronize with the target base station, thereby establishing a new connection between the UE and the target base station.

At operation 235, the target base station sends a connection complete indication to the source base station. The connection complete indication may indicate that a connection has been established between the UE and the target base station.

At operation 240, the source base station releases the resources that were allocated to the UE, thereby completing the handover process.

In some aspects, the connection to the source base station may be broken before the new connection is made to the target base station. This may be referred to as a "break-before-make" handover. In some other aspects, the UE simultaneously maintains connections with the source base station and the target base station during the handover process. This may be referred to as a "make-before-break" handover. In some aspects, the handover occurs between base stations within the same type of network (for example, from one cellular network to another cellular network). In some other aspects, the handover occurs between different types of networks (for example, from a cellular network to a wireless local area network). Additional details regarding these features are described herein.

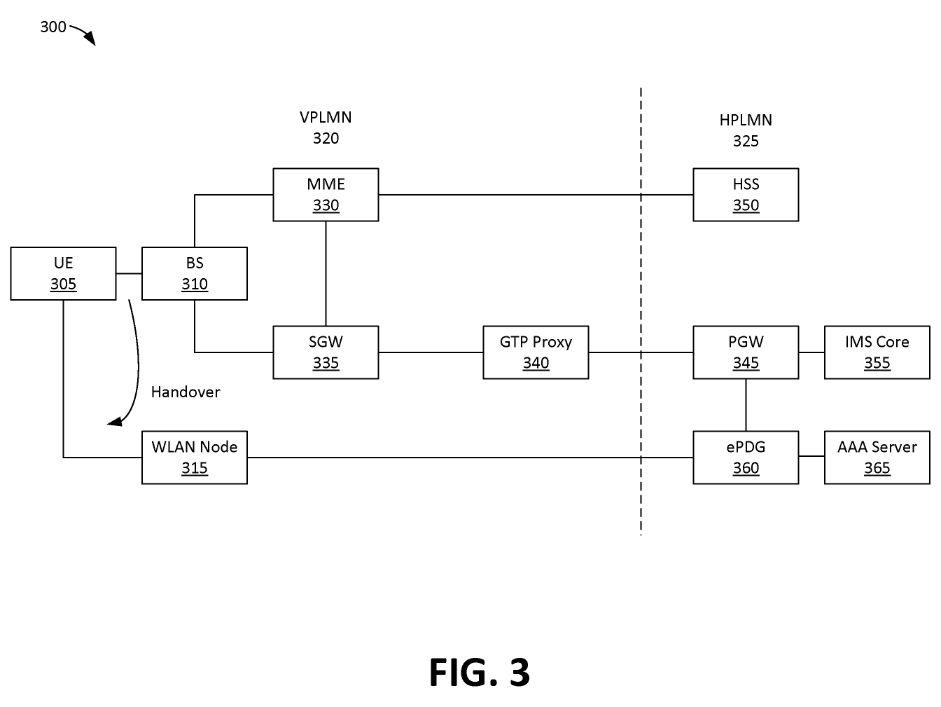

FIG. 3 is a block diagram showing example network components used for communications in cellular networks and wireless local area networks, according to at least one embodiment. An environment 300 may include a UE 305, a BS 310, and a WLAN device 315. The UE 305 may be, or may include one or more features of, the UE 110 described herein. The BS 310 may be, or may include, one or more features of the BS 115 described herein. Additionally, or alternatively, the BS 310 may be any device capable of providing cellular services, such as VoIP services, to the UE 305. The WLAN node 315 may be any device capable of providing Internet services, such as VoWLAN services, to the UE 305.

The VPLMN 320 refers to a mobile network that the UE 305 roams into when it is outside its home network coverage area. The VPLMN 320 provides connectivity and services to the roaming UE 305, ensuring continuity of service through agreements with the HPLMN 325.

The HPLMN 325 is the mobile network to which a subscriber account of the UE 305 is originally registered. The HPLMN 325 handles authentication, billing, and subscriber data management. Additionally, the HPLMN 325 coordinates with the VPLMN 320 to provide seamless service to the UE 305 when the UE 305 is roaming.

The MME 330 is a key control node in 4G LTE networks responsible for managing the mobility and signaling of the UE 305. The MME handles tasks such as authentication, bearer management, handover coordination, and managing the connection state of the UE 305. The MME 330 can interface with the SGW, HSS, and other network entities in order to provide these services.

The SGW 335 is a node in the 4G LTE core network that handles data routing and forwarding between a base station and the PGW. The SGW 335 acts as an anchor point for intra-LTE handovers and manages the user plane, ensuring data packets are properly routed to and from the UE.

The GTP proxy 340 is used to mediate and translate GTP traffic between different network segments or between 3G and 4G networks. The GTP proxy 340 handles the encapsulation and decapsulation of user data packets, ensuring compatibility and continuity across different network types and segments.

The PGW 345 is a key node in the 4G LTE network that connects the LTE network to external packet data networks (e.g., the Internet). The PGW 345 provides IP address allocation, QoS enforcement, policy control, and packet filtering. The PGW 345 may also handle charging and billing for data usage.

The HSS 350 is a central database in LTE networks that contains subscriber-related information, such as user profiles, authentication data, and service entitlements. The HSS 350 supports authentication and authorization processes, subscriber profile management, and mobility management by interacting with the MME and other network entities.

The IP Multimedia Subsystem (IMS) Core 355 is an architectural framework for delivering IP multimedia services over wireless and fixed networks. The IMS core 355 enables services such as VoIP, video calling, messaging, and presence information. Additionally, the IMS core 355 integrates with various access networks and supports seamless multimedia communication.

The Evolved Packet Data Gateway (ePDG) 360 is a network node that provides secure connectivity for UEs accessing the core network over untrusted non-3GPP access networks, such as WLAN networks. The ePDG 360 handles IPsec tunnel establishment and maintenance, ensuring secure data transmission between the UE and the core network.

The Authentication, Authorization, and Accounting (AAA) server 365 refers to a set of network functions that manage user authentication, authorization of services, and accounting for resource usage. The AAA server 365 ensures that only authenticated users can access network resources, authorize user activities based on policies, and keep track of usage for billing and reporting purposes.

The components described above are provided for the purposes of example only. The environment 300 may include other components than the components listed above. Additionally, or alternatively, the environment 300 may include only a subset of the components listed above. The components may have other functions than those described in this figure.

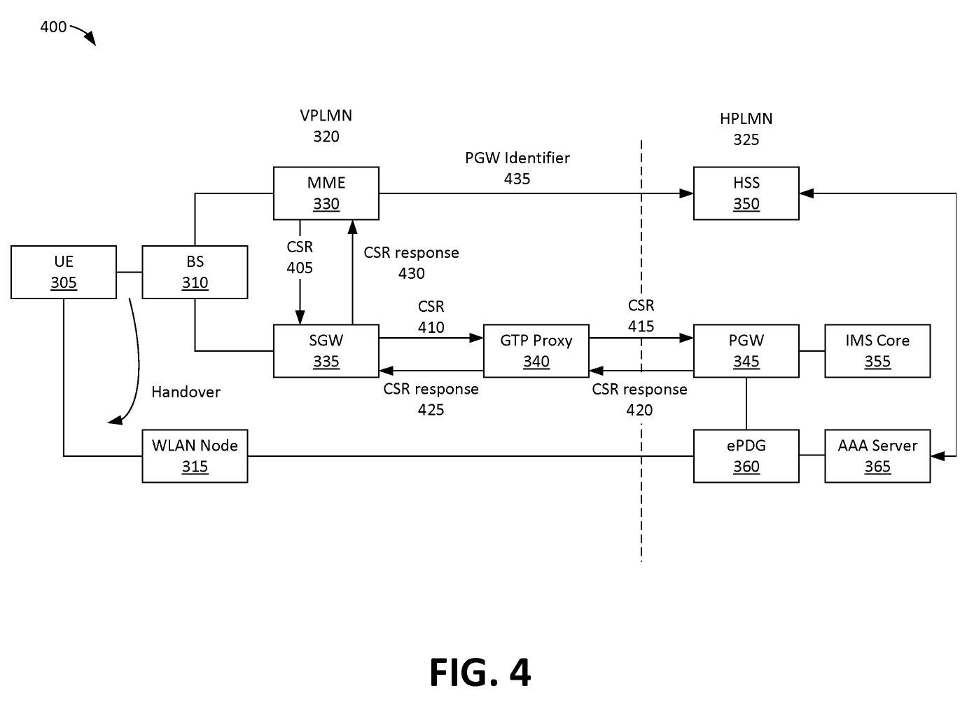

FIG. 4 is a block diagram of an example method 400 of a general packet radio service tunneling protocol proxy (GTP proxy) obtaining a packet data gateway identifier and transferring the packet gateway identifier to the MME for a handover between a cellular network and a wireless local area network, according to at least one embodiment.

At operation 405, the MME 330 sends, and the SGW 335 receives, a create session request (CSR). The CSR can be used to establish a new session for the UE 305, for example, to enable the UE 305 to transmit and receive data services, such as internet services, VoIP calls, or multimedia streaming services, from a network. In some aspects, the CSR may be used in connection with a handover between two or more networks. For example, the MME 330 may send the CSR to the SGW 335 in order to initiate a handover for the UE 305 from the WLAN node 315 to the BS 310. In some aspects, the CSR may include information associated with the UE 305, such as an international mobile subscriber identify (IMSI) of the UE 305, a mobile equipment identity (MEI) indicator, or an IP address, among other examples. Additionally, or alternatively, the CSR may include bearer context information, such as a bearer identifier or a quality of service parameter, an access point name (APN), or a packet data network (PDN) type, among other examples.

At operation 410, the SGW 335 sends, and the GTP proxy 340 receives, the CSR. For example, the SGW 335 may receive the CSR from the MME 330 and may forward the CSR to the GTP proxy 340 without modifying the CSR.

At operation 415, the GTP proxy 340 sends, and the PGW 345 receives, the CSR. In some aspects, the GTP proxy 340 may set a flag, such as a create session request message forward indication (CSRMFI) flag, to a particular value, such as a high value (“1”). After setting the flag to the high value, the GTP proxy 340 sends the CSR to the PGW 345 of the HPLMN 325. Therefore, the CSR sent by the GTP proxy 340 to the PGW 345 may be a modified CSR that includes a flag having a particular value, such as a CSRMFI flag having a high value.

At operation 420, the PGW 345 sends, and the GTP proxy 340 receives, a CSR response. The CSR response may be referred to herein as a “create session request (CSR) response” or, simply, a “create session response.” The CSR response may include a PGW identifier associated with the PGW 345. For example, the CSR response may include a PGW node name associated with the PGW 345. In some aspects, the CSR response may include a PGW fully qualified domain name (FQDN) information element (IE) having a value that identifies the PGW 345. In some aspects, the PGW 345 may receive the CSR with the CSRMFI flag set to the high value and, responsive to receiving the CSR, may send the CSR response having the PGW identifier (such as the PGW FQDN IE with the value that identifies the PGW 345) to the GTP proxy 340 over the S5/S8 interface. In some aspects, sending the CSR response by the PGW 345 may indicate that the PDN connection has been accepted by the PGW 345.

At operation 425, the GTP proxy 340 sends, and the SGW 335 receives, the CSR response. For example, the GTP proxy 340 may send the CSR response having the PGW identifier (such as the PGW FQDN IE with the value that identifies the PGW 345) to the SGW 335. In some aspects, the GTP proxy 340 may send the CSR response having the PGW identifier directly to the MME 330, for example, over an S11 interface. In this case, operation 430 may be optional.

At operation 430, the SGW 335 sends, and the MME 330 receives, the CSR response. For example, the SGW 335 may send the CSR response having the PGW identifier (such as the PGW FQDN IE with the value that identifies the PGW 345) to the MME 330. The SGW 335 may send the PGW identifier to the MME 330 over the S11 interface.

At operation 435, the MME 330 sends, and the HSS 350 receives, the PGW identifier. For example, upon receiving the CSR response, the MME 330 may obtain the PGW identifier (such as the FQDN from the PGW node name IE) from the CSR response and may send the PGW identifier to the HSS 350. The HSS 350 may store the PGW identifier. Thereafter, the HSS 350 may use the PGW identifier, such as the FQDN of the PGW 345, when performing a handover from the BS 310 to the WLAN node 315, such as when performing a handover from VoIP to VoWLAN. As described herein, this may increase a likelihood of the handover being successful due to the correct PGW identifier being stored at the HSS 350.

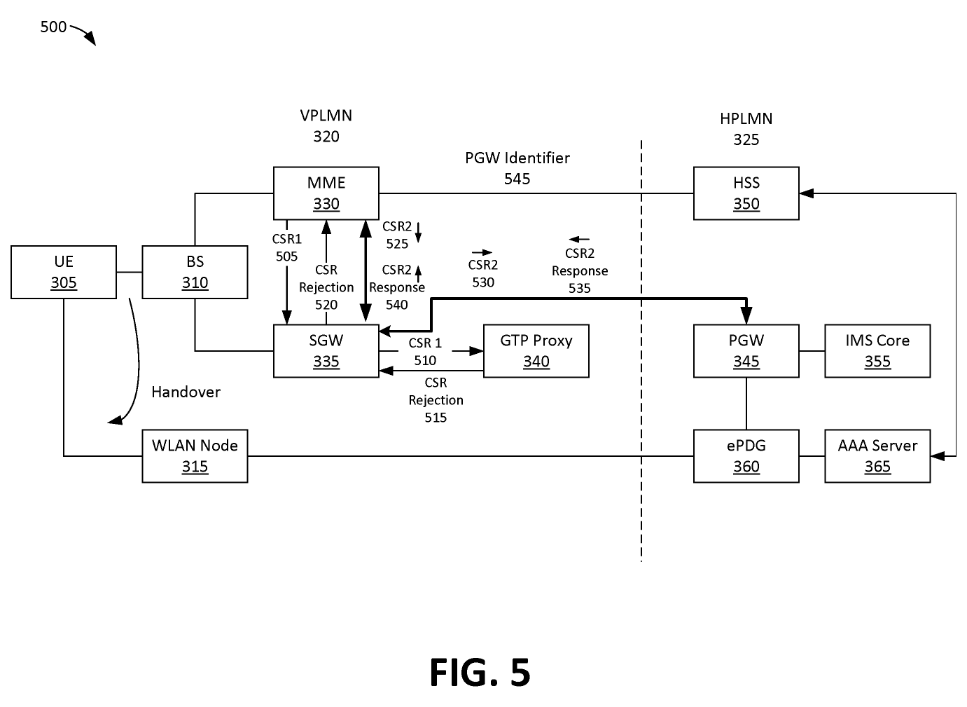

FIG. 5 is a block diagram of an example method 500 of a GTP proxy obtaining a packet data gateway identifier and redirecting the traffic towards the packet data gateway for a handover between a cellular network and a wireless local area network, according to at least one embodiment.

At operation 505, the MME 330 sends, and the SGW 335 receives, a first CSR (shown as CSR1). The CSR can be used to establish a new session for the UE 305, for example, to enable the UE 305 to transmit and receive data services, such as internet services, VoIP calls, or multimedia streaming services, from a network. In some aspects, the CSR may be used in connection with a handover between two or more networks. For example, the MME 330 may send the CSR to the SGW 335 in order to initiate a handover for the UE 305 from the WLAN node 315 to the BS 310 . In some aspects, the CSR may include information associated with the UE 305, such as an IMSI of the UE 305, an MEI indicator, or an IP address, among other examples. Additionally, or alternatively, the CSR may include bearer context information, such as a bearer identifier or a quality of service parameter, an APN, or a PDN type, among other examples.

At operation 510, the SGW 335 sends, and the GTP proxy 340 receives, the CSR. For example, the SGW 335 may receive the CSR from the MME 330 and may forward the CSR to the GTP proxy 340 without modifying the CSR.

At operation 515, the GTP proxy 340 after selecting a PGW of the HPLMN, sends, and the SGW 335 receives, a CSR rejection. The CSR rejection may include an alternative PGW identifier. For example, the CSR rejection may include an alternative FQDN information element having a value (for example, a high value) that indicates the PGW 345 of the HPLMN 325.

At operation 520, the SGW 335 sends, and the MME 330 receives, the CSR rejection. For example, upon receiving the CSR rejection with the alternative PGW FQDN IE from the GTP proxy 340 over the S5/S8 interface, the SGW 335 may forward the CSR rejection to the MME 330 over the S11 interface.

At operation 525, the MME 330 sends, and the SGW 335 receives, a second CSR (shown as CSR2). The second CSR may be based on the alternative PGW identifier included in the CSR rejection. For example, the second CSR may include the PGW FQDN IE included in the CSR rejection.

At operation 530, the SGW 335 sends, and the PGW 345 receives, the second CSR over the S5/S8 interface. The PGW 345, which the SGW 335 sends the second CSR to, is identified by the SGW 335, based on the FQDN or its corresponding IP address information of the PGW 345 in the second CSR message.

At operation 535, the PGW 345 sends, and the SGW 335 receives, a CSR response over the S5/S8 interface. The CSR response is based on the second CSR. In some aspects, sending the second CSR response by the PGW 345 may indicate that the PDN connection has been accepted by the PGW 345.

At operation 540, the SGW 335 sends, and the MME 330 receives, the CSR response over the S11 interface. In some aspects, receiving the second CSR response by the MME 330 may indicate that the PDN connection has been accepted by the PGW 345. The PGW 345 is identified by the MME 330 based on the FQDN or IP address information of the PGW 345, which is included in the second CSR request that the MME 330 constructed based on the alternative PGW identifier included in the first CSR rejection response message.

At operation 545, the MME 330 sends, and the HSS 350 receives, the PGW identifier. For example, upon receiving the second CSR response, the MME 330 uses the PGW identifier (such as the FQDN from the PGW node name IE) obtained from the first CSR rejection response and sends the PGW identifier to the HSS 350. The HSS 350 may store the PGW identifier. Thereafter, the HSS 350 may use the PGW identifier, such as the FQDN of the PGW 345, when performing a handover from the BS 310 to the WLAN node 315, such as when performing a handover from VoIP to VoWLAN. As described herein, this may increase a likelihood of the handover being successful due to the correct PGW identifier being stored at the HSS 350.

In some implementations, a VPLMN comprises a GTP proxy, an SGW, and an MME. The GTP proxy stores first processor-readable instructions which, when executed by the GTP proxy, cause the GTP proxy to perform operations comprising: receiving, from the SGW, a create session request message; modifying the received create session request message with CSRMFI flag set to the high value; selecting a PGW of the HPLMN; sending, to the PGW of an HPLMN, the modified create session request message; receiving, from the PGW of the HPLMN, a create session response message that includes a PGW identifier associated with the PGW of the HPLMN; and sending, to the SGW, the create session response message. The SGW stores second processor-readable instructions which, when executed by the SGW, cause the SGW to perform operations comprising: receiving, from the MME, the create session request message; sending, to the GTP proxy, responsive to receiving the create session request message from the MME, the create session request message; receiving, from the GTP proxy, the create session response message; and sending, to the MME, responsive to receiving the create session response message from the GTP proxy, the create session response message. The MME stores third processor-readable instructions which, when executed by the MME, cause the MME to perform operations comprising: constructing a create session request message; sending, to the SGW, the create session request message; receiving, from the SGW, the create session response message; and updating an HSS of the HPLMN with the PGW identification of the HPLMN.

In some implementations, sending the create session request message by the GTP proxy to the PGW of the HPLMN comprises setting, by the GTP proxy, a create session request message forward indication bit to a high value; and forwarding, by the GTP proxy to the PGW of the HPLMN, the create session request message, wherein the create session request message includes the create session request message forward indication bit having the high value. In some implementations, the third processor-readable instructions, when executed by the MME, further cause the MME to perform operations comprising sending, to an HSS of the HPLMN, an indication of the PGW identifier. In some implementations, the indication of the PGW identifier is included in a notify request information element. In some implementations, the PGW identifier is a PGW node name information element. In some implementations, the PGW node name information element is an FQDN identifier associated with the PGW. In some implementations, the MME sends the create session request message to the SGW responsive to the MME detecting a handover attempt between a voice-over-LTE service and a voice-over-Wi-Fi service.

In some implementations, a VPLMN comprises a GTP proxy, an SGW, and an MME. The GTP proxy stores first processor-readable instructions which, when executed by the GTP proxy, cause the GTP proxy to perform operations comprising: receiving, from the SGW, a first create session request message; selecting a PGW of the HPLMN; sending, to the SGW, responsive to receiving the first create session request message, an error message that includes an indication of the selected PGW of the HPLMN. The SGW stores second processor-readable instructions which, when executed by the SGW, cause the SGW to perform operations comprising: receiving, from the MME, the first create session request message; sending, to the GTP proxy, the first create session request message; receiving, from the GTP proxy, the error message that includes the indication of the PGW of the HPLMN; sending, to the MME, the error message; receiving, from the MME, responsive to receiving the error response message of the first create session request message, a second create session request message that includes the indication of the PGW of the HPLMN; sending, to the PGW of the HPLMN based on the indication information of the PGW of the HPLMN included in the second create session request message, the second create session request message; receiving, from the PGW of the HPLMN, a create session response message; and sending, to the MME, the create session response message. The MME stores third processor-readable instructions which, when executed by the MME, cause the MME to perform operations comprising: constructing a first create session request message; sending, to the SGW, the first create session request message; receiving, from the SGW, the error response message; constructing a second create session request message, responsive to receiving the error response message of the first create session request message; sending, to the SGW, the second create session request message; receiving, from the SGW, the create session response message; and updating an HSS of the HPLMN with the PGW identification of the HPLMN.

In some implementations, the third processor-readable instructions, when executed by the MME, further cause the MME to perform operations comprising sending, to an HSS of the HPLMN, an indication of the PGW identifier. In some implementations, the indication of the PGW identifier is included in a notify request information element. In some implementations, the first processor-readable instructions, when executed by the GTP proxy, further cause the GTP proxy to perform operations comprising selecting an PGW of the HPLMN; determining that the PGW identifier in the first create session request message is different than the identifier of the selected PGW of the HPLMN; and constructing an error response message that includes the identifier of the selected PGW of the HPLMN, in response to the first create session request message. In some implementations, the error response message is a create session request rejection message that includes an alternative PGW identifier based on the identifier of the selected PGW of the HPLMN. In some implementations, the alternative PGW identifier is an FQDN identifier associated with the PGW of the HPLMN. In some implementations, the third processor-readable instructions, when executed by the MME, further cause the MME to perform operations comprising generating the second create session request message based on the alternative PGW identifier, responsive to receiving the error response message to the first create session request message. In some implementations, the MME sends the first create session request message to the SGW responsive to the MME detecting a handover attempt between a voice-over-LTE service and a voice-over-Wi-Fi service.

In some implementations, an HPLMN comprises a PGW and an HSS. The PGW stores first processor-readable instructions which, when executed by the PGW, cause the PGW to perform operations comprising: receiving, from a network component of a VPLMN, a create session request message; generating a create session response message, responsive to the received create session request message; and sending, to the network component of the VPLMN, a create session response message. In some implementations, the received create session request, from the network component of a VPLMN, includes a CSRMFI flag set to the high value; and the generated created session response message, by the PGW of the HPLMN, includes a PGW identifier associated with the PGW. The HSS storing second processor-readable instructions which, when executed by the HSS, cause the HSS to perform operations comprising: receiving, from an MME of the VPLMN, an indication of the PGW identifier; and storing the PGW identifier in a memory associated with the HSS. In some implementations, the network component is a GTP proxy of the VPLMN. In some implementations, the network component is a serving gateway of the VPLMN. In some implementations, the second processor-readable instructions, when executed by the HSS, further cause the HSS to perform operations comprising providing the PGW identifier to a core network component of the HPLMN or an ePDG of the HPLMN. In some implementations, the HSS receives the indication of the PGW identifier in accordance with a PDN connectivity establishment.

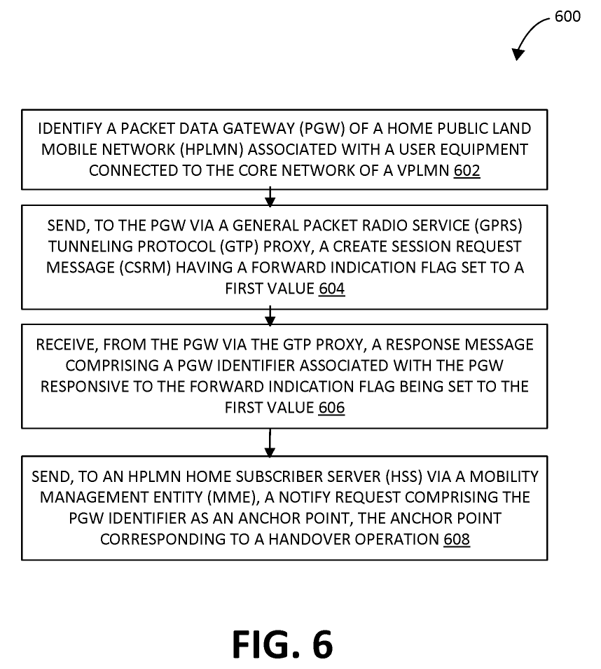

FIG. 6 is a flow diagram of a method 600 of obtaining a packet data gateway identifier for a handover between a cellular network and a wireless local area network, according to at least one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 600 is performed by the handover component 150 of FIG. 1. In one embodiment, the method 600 is performed by a first core network. The method 600 can be performed by other computing systems described herein.

Referring to FIG. 6, the method 600 begins with the processing logic identifying PGW of a HPLMN associated with a user equipment connected to the core network of a VPLMN (block 602). At block 604, the processing logic sends, to the PGW via a GTP proxy, a create session request message (CSRM) having a forward indication flag set to a first value. At block 606, the processing logic receives, from the PGW via the GTP proxy, a response message comprising a PGW identifier associated with the PGW responsive to the forward indication flag being set to the first value. At block 608, the processing logic sends, to a HSS via a MME, a notify request comprising the PGW identifier as an anchor point, the anchor point corresponding to a handover operation. The PGW identifier can be used as the anchor point instead of an IP address of the GTP proxy.

In a further embodiment, the handover operation is a handover attempt between a voice service from the VPLMN to a VoWLAN service. In another embodiment, the CSRM having the forward indication flag set to the first value is sent to the PGW via the GTP proxy responsive to detecting a handover attempt between a voice-over-LTE service and a voice-over-Wi-Fi service. The processing logic at block 604 can send the CSRM having the forward indication flag set to the first value the PGW via the GTP proxy is responsive to the detecting the handover attempt.

In another embodiment, at block 604, the processing logic sets, using the GTP proxy, the forward indication flag bit to the first value in the CSRM received from the MME and forwards, by the GTP proxy to the PGW of the HPLMN, the CSRM having the forward indication flat set to the first value.

In a further embodiment, the notify request includes an information element comprising the PGW identifier. In another embodiment, the PGW identifier is a PGW node name information element. The PGW node name information element can be a fully qualified domain name (FQDN) identifier associated with the PGW.

In another embodiment, the core network of the VPLMN includes the GTP proxy, the SGW, the MME. The processing logic of the GTP proxy can receive, from the SGW, the CSRM, select the PGW of the HPLMN, modify the CSRM with the forward indication flag set to the first value, send, to the PGW, the CSRM, receive, from the PGW, the response message comprising the PGW identifier, and send, to the SGW, the response message.

In another embodiment, the core network of the VPLMN includes the GTP proxy, the SGW, the MME. The processing logic of the SGW can receive, from the MME, the CSRM, receive, from the GTP proxy, the response message comprising the PGW identifier, send, to the GTP proxy, responsive to receiving the CSRM from the MME, the CSRM, receive, from the GTP proxy, the CSRM, and send, to the MME, responsive to receiving the CSRM from the GTP proxy, the response message.

In another embodiment, the core network of the VPLMN includes the GTP proxy, the SGW, the MME. The processing logic of the MME can select the SGW and the PGW, generate the CSRM that identifies the GTP proxy as the selected PGW, send, to the SGW, the CSRM;

receive, from the SGW, the response message, and update, to the HSS of the HPLMN, the PGW identifier.

One or more non-transitory, computer-readable storage media storing computer-readable instructions stored thereon which, when executed by one or more processing devices, cause the one or more processing devices to perform the operations described above with respect to FIG. 6.

In the above description, numerous details are set forth. It will be apparent, however, to one of ordinary skill in the art having the benefit of this disclosure, that aspects may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” “generating” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A computing system to implement a core network of a visited public land mobile network (VPLMN), the computing system comprising:
one or more processing devices; and
one or more computer-readable storage medium storing instructions that when executed by the one or more processing devices cause the one or more processing devices to perform operations comprising:
identifying a packet data gateway (PGW) of a home public land mobile network (HPLMN) associated with a user equipment connected to the core network of the VPLMN;
sending, to the PGW via a general packet radio service (GPRS) tunneling protocol (GTP) proxy, a create session request message (CSRM) having a forward indication flag set to a first value;
receiving, from the PGW via the GTP proxy, a response message comprising a PGW identifier associated with the PGW responsive to the forward indication flag being set to the first value; and
sending, to an HPLMN home subscriber server (HSS) via a mobility management entity (MME), a notify request comprising the PGW identifier as an anchor point, the anchor point corresponding to a handover operation.

2. The computing system of claim 1, wherein the handover operation is a handover attempt between a voice service from the VPLMN to a Voice over Wireless Local Area Network (VoWLAN) service.

3. The computing system of claim 1, wherein the core network of the VPLMN comprises:
the GTP proxy;
a serving gateway (SGW); and
a mobility management entity (MME), wherein the GTP proxy is to:
receive, from the SGW, the CSRM;
select the PGW of the HPLMN;
modify the CSRM with the forward indication flag set to the first value;
send, to the PGW, the CSRM;
receive, from the PGW, the response message comprising the PGW identifier; and
send, to the SGW, the response message.

4. The computing system of claim 1, wherein the core network of the VPLMN comprises:
the GTP proxy;
a serving gateway (SGW); and
a mobility management entity (MME), wherein the SGW is to:
receive, from the MME, the CSRM;
receive, from the GTP proxy, the response message comprising the PGW identifier;
send, to the GTP proxy, responsive to receiving the CSRM from the MME, the CSRM;
receive, from the GTP proxy, the CSRM; and
send, to the MME, responsive to receiving the CSRM from the GTP proxy, the response message.

5. The computing system of claim 1, wherein the core network of the VPLMN comprises:
the GTP proxy;
a serving gateway (SGW); and
a mobility management entity (MME), wherein the MME is to:
select the SGW and the PGW;
generate the CSRM that identifies the GTP proxy as the selected PGW;
send, to the SGW, the CSRM;
receive, from the SGW, the response message; and
update, to the HSS of the HPLMN, the PGW identifier.

6. The VPLMN of claim 1, wherein sending the CSRM to the PGW via the GTP proxy comprises:
setting, using the GTP proxy, the forward indication flag bit to the first value in the CSRM received from the MME; and
forwarding, by the GTP proxy to the PGW of the HPLMN, the CSRM having the forward indication flat set to the first value.

7. The VPLMN of claim 1, wherein the notify request comprises an information element comprising the PGW identifier.

8. The VPLMN of claim 1, wherein the PGW identifier is a PGW node name information element.

9. The VPLMN of claim 8, wherein the PGW node name information element is a fully qualified domain name (FQDN) identifier associated with the PGW.

10. The VPLMN of claim 1, wherein the CSRM having the forward indication flag set to the first value is sent to the PGW via the GTP proxy responsive to detecting a handover attempt between a voice-over-LTE service and a voice-over-Wi-Fi service.

11. A method of operating a core network of a visited public land mobile network (VPLMN), the method comprising:
identifying a packet data gateway (PGW) of a home public land mobile network (HPLMN) associated with a user equipment connected to the core network of a VPLMN;
sending, to the PGW via a general packet radio service (GPRS) tunneling protocol (GTP) proxy, a create session request message (CSRM) having a forward indication flag set to a first value;
receiving, from the PGW via the GTP proxy, a response message comprising a PGW identifier associated with the PGW responsive to the forward indication flag being set to the first value; and
sending, to an HPLMN home subscriber server (HSS) via a mobility management entity (MME), a notify request comprising the PGW identifier as an anchor point, the anchor point corresponding to a handover operation.

12. The method of claim 11, wherein the handover operation is a handover attempt between a voice service from the VPLMN to a Voice over Wireless Local Area Network (VoWLAN) service.

13. The method of claim 11, wherein sending the CSRM to the PGW via the GTP proxy comprises:
setting, using the GTP proxy, the forward indication flag bit to the first value in the CSRM received from a mobility management entity (MME); and
forwarding, by the GTP proxy to the PGW of the HPLMN, the CSRM having the forward indication flat set to the first value.

14. The method of claim 11, wherein the notify request comprises an information element comprising the PGW identifier.

15. The method of claim 11, wherein the PGW identifier is a PGW node name information element.

16. The method of claim 15, wherein the PGW node name information element is a fully qualified domain name (FQDN) identifier associated with the PGW.

17. The method of claim 11, further comprising detecting a handover attempt between a voice-over-LTE service and a voice-over-Wi-Fi service, wherein sending the CSRM having the forward indication flag set to the first value the PGW via the GTP proxy is responsive to the detecting the handover attempt.

18. One or more non-transitory, computer-readable storage media storing computer-readable instructions stored thereon which, when executed by one or more processing devices, cause the one or more processing devices to perform the operations comprising:
identifying a packet data gateway (PGW) of a home public land mobile network (HPLMN) associated with a user equipment connected to the core network of the VPLMN;
sending, to the PGW via a general packet radio service (GPRS) tunneling protocol (GTP) proxy, a create session request message (CSRM) having a forward indication flag set to a first value;
receiving, from the PGW via the GTP proxy, a response message comprising a PGW identifier associated with the PGW responsive to the forward indication flag being set to the first value; and
sending, to an HPLMN home subscriber server (HSS) via a mobility management entity (MME), a notify request comprising the PGW identifier as an anchor point, the anchor point corresponding to a handover operation.

19. The one or more non-transitory, computer-readable storage media of claim 18, wherein the handover operation is a handover attempt between a voice service from the VPLMN to a Voice over Wireless Local Area Network (VoWLAN) service.

20. The one or more non-transitory, computer-readable storage media of claim 18, wherein the PGW identifier is a PGW node name information element, wherein the PGW node name information element is a fully qualified domain name (FQDN) identifier associated with the PGW.
